(19) United States
(12) Patent Application Publication
(10) Pub. No.: US 2006/0101655 A1
(43) Pub. Date: May 18, 2006

(54) Apparatus for removing body hair

(76) Inventor: Philip Givant, Fair Oaks, CA (US)

Correspondence Address: JAMES RAY & ASSOCIATES, 2640 PITCAIRN ROAD, MONROEVILLE, PA, 15146, US

(21) Appl. No.: 11/252,331

(22) Filed: Oct. 17, 2005

Related U.S. Application Data
(60) Provisional application No. 60/628,886, filed on Nov. 17, 2004.
(60) Provisional application No. 60/668,836, filed on Apr. 6, 2005.

(51) Int. Cl. B27B 21/00

(52) U.S. Cl. 30/523

(57) ABSTRACT

An apparatus for removing body hair. The apparatus comprises an elongated flexible handle having each of a predetermined length and shape, formed from a pre-selected material. The handle has a first end and a second end. The predetermined length is at least sufficient for reaching longer distances with minimal bending and stretching. A gripping means is disposed on the flexible handle. A connecting means is disposed on the first end of the flexible handle. The connecting means is detachably engageable with a shaving means, whereby potential back strain and injury to the user is reduced.

### CROSS-REFERENCE TO RELATED APPLICATIONS

This application is related to and claims priority from U.S. Provisional Patent Application Ser. Nos. 60/628,886 filed Nov. 17, 2004, and 60/668,836 filed Apr. 6, 2005.

### FIELD OF THE INVENTION

The present invention relates, in general, to removing body hair, and more particularly, to an apparatus for removing body hair.

### BACKGROUND OF THE INVENTION

Prior to the present invention, standard shaving razors have been used to remove unwanted hair from various parts of the body, such as underarms, legs, and back. Because of their relatively short handles, shaving hard to reach areas such as legs, back, and even underarms for persons with disabilities is awkward and uncomfortable. Back strain can occur as well while the user is bending and stretching. Several current shaving razors with handle extensions are designed to address this problem. U.S. Pat. No. 4,905,372 discloses a razor handle extension which is adapted to be detachably connected to the handle of a disposable razor to effectively increase the length of the handle and thereby permit a female user to more easily and safely shave her legs from an erect position. The disadvantage of this design is that the razor handle extension is rigid and straight, and suited for reaching limited areas of the body. U.S. Pat. No. 5,911,480 discloses a razor having an extendable, telescoping handle wherein the handle has at least one telescoping segment, which is slidingly moveable and frictionally securable to a number of extendable positions. This design further discloses that at least one telescoping segment comprises a flexible and resilient material. The disadvantage of this design is that the telescoping segments are secured by a brace member, which comprises a locking ring or nut, flexible locking wrap material, a clamping device, or other device or material well known in the art for connecting various components. This brace member needs to be loosened and tightened every time the user desires to shave a different body area, and can also trap dirt and debris, which can create an unsanitary condition. U.S. Pat. No. 6,189,222 discloses an articulated razor handle extension in which the handle and the gripping head are joined by a plurality of shaft sections, which are releasably connected by at least one spur gear assembly. The disadvantage of this design is that each spur gear must be loosened and tightened to move and secure respectively each shaft section in the appropriate formation necessary to reach that part of the body that the user desires to shave. Additionally, shaft sections are designed to be removed or added as necessary to shorten or lengthen the extension. Both operations can be a time-consuming trial and error process until the appropriate adjustments are made.

### SUMMARY OF THE INVENTION

In a first aspect, the present invention provides an apparatus for removing body hair. The apparatus comprises an elongated flexible handle having each of a predetermined length and shape, formed from a pre-selected material, and having a first end and a second end. The predetermined length is at least sufficient for reaching longer distances with minimal bending and stretching. A gripping means is disposed on the elongated flexible handle. A connecting means is disposed on the first end of the flexible elongated handle. The connecting means is detachably engageable with a shaving means, whereby the apparatus will reduce potential back strain and injury to the user.

In a further aspect, the present invention provides an apparatus for removing body hair. The apparatus comprises an elongated flexible handle having each of a predetermined length and shape, formed from a pre-selected material, and having a first end and a second end. The predetermined length is at least sufficient for reaching longer distances with minimal bending and stretching. A gripping means is disposed on the elongated flexible handle. A shaving means for removing body hair is at least one of rigidly and rotatably disposed on the first end of the elongated flexible handle, whereby the apparatus will reduce potential back strain and injury to the user.

In a further aspect, the present invention provides an apparatus for removing leg hair. The apparatus comprises an elongated rigid handle having each of a predetermined length and shape. The rigid handle is formed from a preselected material, having a first end and a second end. The predetermined length is at least sufficient for reaching longer distances with minimal bending and stretching. A gripping means disposed on the rigid handle, and a connecting means is disposed on the first end of the rigid handle. The connecting means is detachably engageable with a shaving means, whereby the apparatus will reduce potential back strain and injury to the user.

### OBJECTS OF THE INVENTION

It is therefore a primary object of the present invention to provide an apparatus for comfortably removing body hair from hard to reach extremities.

Another object of the present invention is to provide an apparatus for removing body hair from hard to reach extremities by easily adjusting the flexible handle to the desired angle.

Another object of the invention is to provide an apparatus for removing body hair that reduces the potential back strain and injury to the user.

Another object of the present invention is to provide an apparatus for removing body hair that comprises very few parts and is easy to clean and maintain.

In addition to the various objects of the invention that have been described above, various other objects and advantages of the invention will become readily apparent to those persons skilled in the relevant art from the following more detailed description of the invention, particularly, when such description is taken in conjunction with the attached drawing figures and the appended claims.

### BRIEF DESCRIPTION OF THE DRAWINGS

FIG. 1 is an isometric view of the apparatus for removing body hair;

FIG. 2 is an isometic view of an alternative embodiment of the apparatus for removing body hair;

FIG. 3 is an illustration of the apparatus for removing body hair in use on the legs; and

FIG. 4 is an illustration of the apparatus for removing body hair in use on the back.

### BRIEF DESCRIPTION OF A PRESENTLY PREFERRED AND VARIOUS ALTERNATIVE EMBODIMENTS OF THE PRESENT INVENTION

Prior to proceeding to a more detailed description of the invention, it should be noted that identical components having identical functions have been designated with identical reference numerals for the sake of clarity.

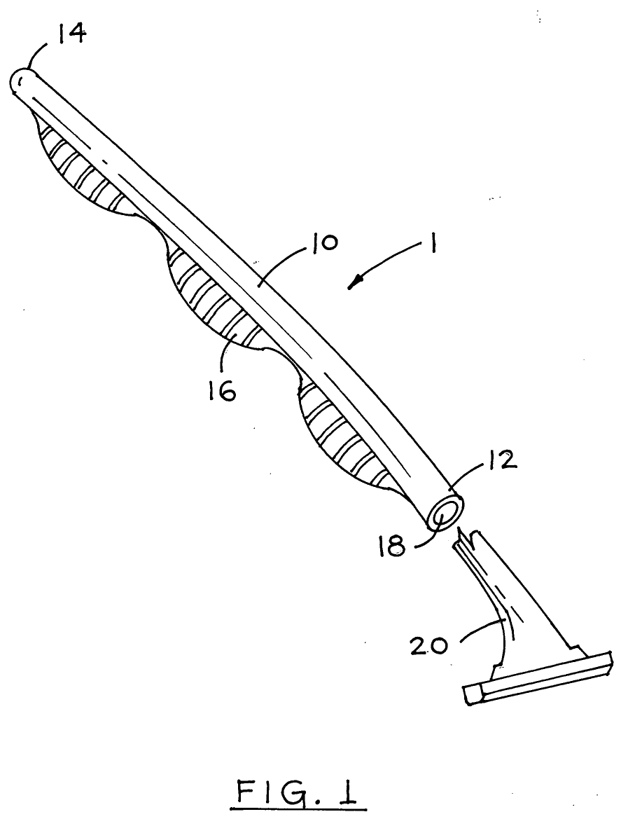

Now refer more particularly to FIGS. 1, 3 and 4 of the drawings. Illustrated therein is an apparatus for removing body hair, generally designated 1. The apparatus comprises an elongated flexible handle 10 having each of a predetermined length and shape. The preferred shape of the flexible handle 10 is at least one of articulate and bendable. The present preferred shape of the flexible handle 10 is bendable. The flexible handle 10 is formed from a pre-selected material. The present preferred pre-selected material is elastic encased flexible tubing. The flexible tubing can consist of a thin copper tube, which can be bent to the desired angle for easily reaching various body extremities while remaining in a relatively erect position. The elongated flexible handle 10 has a first end 12 and a second end 14. The predetermined length is at least sufficient for reaching longer distances with minimal bending and stretching. Preferably, the length of the flexible handle is generally about twenty six inches. This length will allow for a variety of uses with one apparatus. A gripping means 16 is disposed on the flexible handle 10. Preferably, the gripping means 16 contains a plurality of concave and convex portions of a predetermined size, shape, and material. Preferably, the concave and convex portions are disposed a predetermined distance along the length of the flexible handle 10. Preferably, the convex portions are generally about two inches long, and comprise a soft tactile surface. The user can comfortably grip the flexible handle 10 at the various concave and convex locations to achieve the desired reaching distance depending on the part of the body that the user wishes to shave. A connecting means 18 is disposed on the first end 12 of the flexible handle 10. The present preferred shaving means 20 is a shaving razor with a handle. The connecting means 18 is detachably engageable with the handle of a shaving razor. The preferred connecting means 18 is a receptacle of a predetermined size and shape for detachably connecting the handle of a shaving razor. Preferably, the receptacle is an orifice.

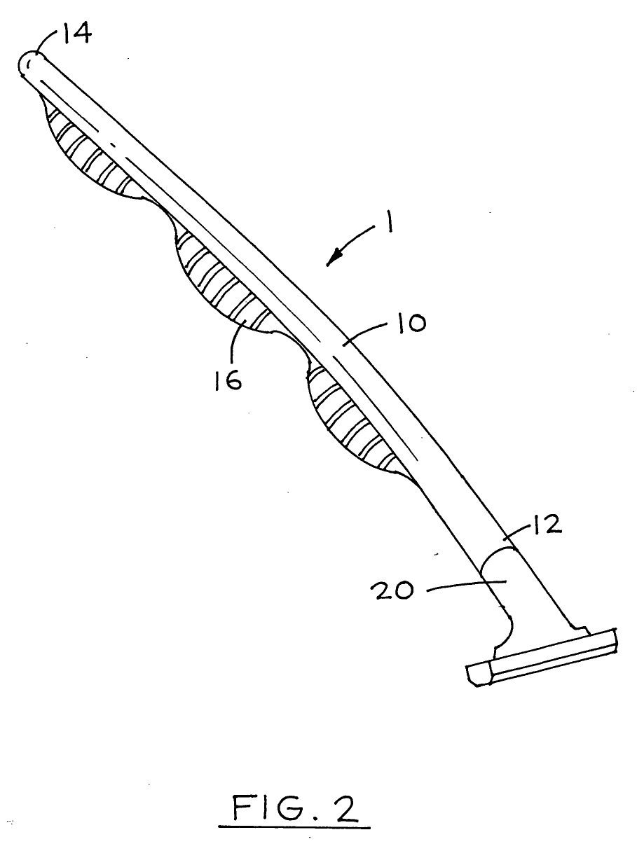

Now refer more particularly to FIGS. 2, 3, and 4 of the drawings. Illustrated therein is an apparatus for removing body hair, generally designated 1. The apparatus comprises an elongated flexible handle 10 having each of a predetermined length and shape. The preferred shape of the flexible handle 10 is at least one of articulate and bendable. The present preferred shape of the flexible handle 10 is bendable. The flexible handle 10 is formed from a pre-selected material. Preferably, the pre-selected material is elastic encased flexible tubing. The flexible tubing can consist of a thin copper tube, which can be bent to the desired angle for easily reaching various body extremities while remaining in a relatively erect position. The elongated flexible handle 10 has a first end 12 and a second end 14. The predetermined length is at least sufficient for reaching longer distances with minimal bending and stretching. Preferably, the length of the flexible handle is generally about twenty six inches. This length will allow for a variety of uses with one apparatus. A gripping means 16 is disposed on the flexible handle 10. Preferably, the gripping means 16 contains a plurality of concave and convex portions of a predetermined size, shape, and material. Preferably, the concave and convex portions are disposed a predetermined distance along the length of the elongated flexible handle 10. Preferably, the convex portions are generally about two inches long, and comprise a soft tactile surface. The user can comfortably grip the flexible handle 10 at the various concave and convex locations to achieve the desired reaching distance depending on the part of the body that the user wishes to shave. A shaving means 20 for removing body hair is at least one of rigidly and rotatably disposed on the first end 12 of the elongated flexible handle 10. The present preferred shaving means 20 is a shaving razor that is rotatably disposed on the elongated flexible handle 10, so that the razor can be rotated and adjusted to a suitable position relative to the area of the body that is being shaved.

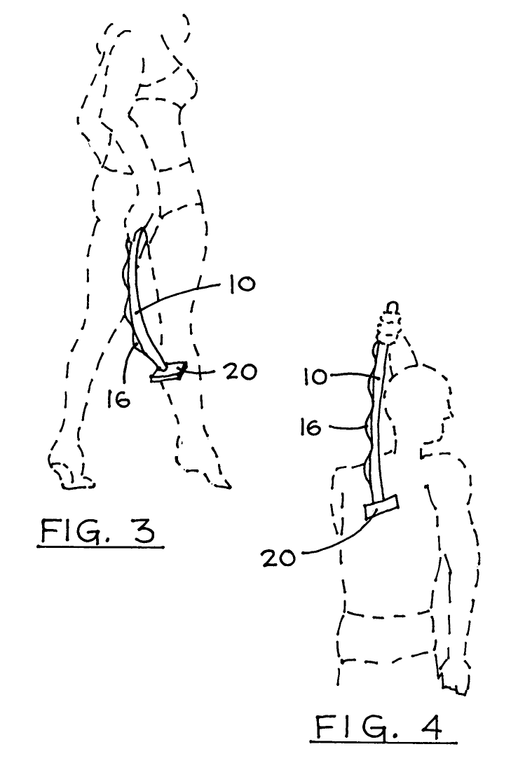

Now refer again more particularly to FIGS. 1 and 3 of the drawings. Illustrated therein is an apparatus for removing leg hair, generally designated 1. An elongated rigid handle 10 has each of a predetermined length and shape. The rigid handle 10 is formed from a preselected material, having a first end 12 and a second end 14, with a predetermined length being at least sufficient for reaching longer distances with minimal bending and stretching. A gripping means 16 is disposed on the rigid handle 10, and a connecting means 18 is disposed on the first end 12 of the rigid handle 10. The connecting means 18 is detachably engageable with a shaving means 20. The apparatus 1 will reduce potential back strain and injury to the user when shaving the legs.

Although the invention has been shown in connection with a certain specific embodiment, it will be readily apparent to those skilled in the art that various changes in form and arrangement of parts may be made to suit requirements without departing from the spirit and scope of the invention.

I claim:

1. An apparatus for removing body hair, said apparatus comprising:
(a) an elongated flexible handle having each of a predetermined length and shape, said flexible handle formed from a preselected material, having a first end and a second end, said predetermined length being at least sufficient for reaching longer distances with minimal bending and stretching;
(b) a gripping means disposed on said flexible handle; and
(c) a connecting means disposed on said first end of said flexible handle, said connecting means detachably engageable with a shaving means, whereby said apparatus will reduce potential back strain and injury to the user.

2. The apparatus according to claim 1 whereby said flexible handle is at least one of articulate and bendable.

3. The apparatus according to claim 2 whereby said flexible handle is bendable.

4. The apparatus according to claim 1 whereby said preselected material of said flexible handle is elastic encased flexible tubing.

5. The apparatus according to claim 1 whereby said predetermined length is generally about twenty six inches.

6. The apparatus according to claim 1 whereby said gripping means contains a plurality of concave and convex portions of a predetermined size, shape, and material.

7. The apparatus according to claim 6 whereby said concave and convex portions are disposed a predetermined distance along the length of said flexible handle.

8. The apparatus according to claim 7 whereby said convex portions are generally about two inches long.

9. The apparatus according to claim 8 whereby said material of said convex portions comprise a soft tactile surface.

10. The apparatus according to claim 1 whereby said shaving means is a shaving razor, said shaving razor has a handle, and said connecting means comprises a receptacle of a predetermined size and shape for detachably connecting such handle of such shaving razor to said flexible handle.

11. The apparatus according to claim 10 whereby said receptacle is an orifice.

12. An apparatus for removing body hair, said apparatus comprising:
(a) an elongated flexible handle having each of a predetermined length and shape, said flexible handle formed from a preselected material, having a first end and a second end, said predetermined length being at least sufficient for reaching longer distances with minimal bending and stretching;
(b) a gripping means disposed on said elongated handle; and
(c) a shaving means for removing such body hair, said shaving means at least one of rigidly and rotatably disposed on said first end of said flexible handle, whereby said apparatus will reduce potential back strain and injury to the user.

13. The apparatus according to claim 12 whereby said flexible handle is at least one of articulate and bendable.

14. The apparatus according to claim 13 whereby said flexible handle is bendable.

15. The apparatus according to claim 13 whereby said preselected material of said flexible handle is elastic encased flexible tubing.

16. The apparatus according to claim 13 whereby said predetermined length of said flexible handle is generally about twenty six inches.

17. The apparatus according to claim 13 whereby said gripping means contains a plurality of concave and convex portions of a predetermined size, shape, and material.

18. The apparatus according to claim 17 whereby said concave and convex portions are disposed a predetermined distance along the length of said handle.

19. The apparatus according to claim 17 whereby said material of said convex portions comprise a soft tactile surface.

20. The apparatus according to claim 13 whereby said shaving means is a shaving razor being rotatably disposed on said flexible handle.

21. An apparatus for removing leg hair, said apparatus comprising:
(a) an elongated rigid handle having each of a predetermined length and shape, said rigid handle formed from a preselected material, having a first end and a second end, said predetermined length being at least sufficient for reaching longer distances with minimal bending and stretching;
(b) a gripping means disposed on said rigid handle; and
(c) a connecting means disposed on said first end of said rigid handle, said connecting means detachably engageable with a shaving means, whereby said apparatus will reduce potential back strain and injury to the user.
